(19) United States
(12) Patent Application Publication
(10) Pub. No.: US 2001/0035936 A1
(43) Pub. Date: Nov. 1, 2001

(54) Eyeglass lens protector

(76) Inventor: Hugo J. Maisnik, Monterey Park, CA (US)

Correspondence Address: Terrell P. Lewis, Unit#8, 343 Palos Verdes Boulevard, Redondo Beach, CA, 90277, US

(21) Appl. No.: 09/858,347

(22) Filed: May 14, 2001

Related U.S. Application Data
(63) Continuation-in-part of application No. 08/775,874, filed on Jan. 2, 1997, now Pat. No. 6,230,711.

(51) Int. Cl. G02C 1/00; G02C 7/02

(52) U.S. Cl. 351/166; 351/159

(57) ABSTRACT

A method and device for protecting the lenses of a pair of eyeglasses from getting scratched wherein the device is a strip of flexible polyvinyl chloride (PVC) material having at least one surface possessing clinging properties and having an exterior configuration which resembles the shape of the side-by-side eyeglass lenses, and the method comprises the steps of positioning the strip of flexible PVC material atop an outer surface of the lenses, and pressing the surface of the PVC strip into contact against and into contact with the outer surface of said lenses.

The present invention is a continuation-in-part of applicant's currently co-pending U.S. application Ser. No. 09/775,874 filed May 15, 2001, the disclosure of which is incorporated herein by way of reference.

### FIELD OF THE INVENTION

This invention relates to a reusable lens protector for eyeglasses, and more particularly, to a reusable flexible disposable strip of high tensile strength polyvinyl chloride (PVC) having adhesive properties and which can be reused virtually indefinitely. The strip of PVC is provided with a configuration suitable for simultaneously covering and adhering to one side of both lenses of a pair of eyeglasses.

### BACKGROUND OF THE INVENTION

Eyeglass protectors are well known in the art, and typically take various forms. The most commonly used is a container into which the folded eyeglasses are inserted and retained. The container may have rigid sides and define a specific internal shape suitable for, and configured to, hold and protect the folded eyeglasses. A variation of the eyeglass protective container has soft or flimsy sides, sometimes cushioned, to form a protective package which envelopes and contains the folded eyeglasses.

Other eyeglass protectors of known configuration take the form of a shield protecting the lenses of the eyeglasses being worn by the user. For example, in U.S. Pat. No. 5,796,460, there is taught an eyeglass protector which is a curved, flexible band member made of a durable plastic having a center section and opposing temple sections. The lower surface of the band member rests on the upper surface of the eyeglass frame. A bendable, transparent plastic visor shield covers both lenses of a pair of eyeglasses, and is detachably connected to the center section of the band member by several connecting pin members and a corresponding number of pin covers. The band member also includes a pair of bracing elements for retaining the band member in a curved configuration.

The foregoing examples of eyeglass lens protectors are bulky, often heavy, multi-element contrivances, and require the user to carry or store the protector in a pocket or other storage area on or near the user's body whenever the protector is not in use. Further, these eyeglass protectors are typically breakable and rendered inoperative if dropped, stepped on or immersed or otherwise subjected to liquid immersion.

There is therefore a great and long-felt need for an eyeglass lens protector which is light weight, not cumbersome in construction, unbreakable, easy to store, inexpensive and simple in design.

It is therefore an object of the present invention to provide an eyeglass lens protector that possesses strong adhesive and clinging properties without the need for any externally applied adhesives or mechanical fastening means.

Another objective of the present invention is to provide an eyeglass lens protector which possesses sufficient tensile strength to allow for the application of the eyeglass protector under extreme or adverse environmental conditions, such as high heat or humidity conditions, while enabling quick removal and reapplication virtually an unlimited number of times.

Still another objective of the present invention is to provide a thin, flexible eyeglass lens protector for covering the lenses of a pair of eyeglasses while providing a scratch-proof protective surface for the covered lenses.

Yet another objective of the invention is to provide an eyeglass lens protector which can be dropped, stepped on, folded or crumpled up, or immersed in liquids, without fear of destruction or being rendered inoperative.

The present invention achieves these objectives and others not stated above through its simplicity of construction, configuration and use. The eyeglass lens protector of the present invention comprises a single, thin, flexible sheet of polyvinyl chloride (PVC) material having an exterior configuration which resembles two lenses disposed side-by-side. The material of which the eyeglass lens protector is made simulates all essential properties of disposable adhesive-bearing materials, or materials using mechanical binding means. The double pressed, polished, PVC exhibits electrostatic, adhesive properties which renders unnecessary the use of any adhesive or mechanical fastening devices to achieve a strong, yet readily reversible, fastening or binding, which can be achieved by merely pressing the PVC strip of the eyeglass lens protector against the lens surface, but which attains an even stronger adhesion by first stretching the PVC strip before pressing it against the lens surface.

These and other objects of the invention will become readily apparent to those skilled in the art from the following description and appended claims.

### SUMMARY OF THE INVENTION

The instant invention employs double pressed polished PVC strips that provide attachment properties so that no fasteners or adhesives are required to secure the eyeglass lens protector to the outer surfaces of a pair of eyeglasses. These attachment properties facilitate ready and facile removal and thereafter adjustment, before re-attachment, of the inventive eyeglass lens protector.

The instant invention further teaches a double pressed polished PVC securement strip or “tape” that possesses increased self-clinging or binding properties that are not present in other polymeric films or in other vinyl formulations. While many polymeric films and related materials undergo a finishing process that involves polishing and related procedures they do not incorporate a double pressed polished procedure that involves the double pressing and polishing of both surfaces of the PVC as a final processing step in the manufacturing procedure of the product. This double pressed polished procedure results in a greater level of electrostatic, intra-molecular surface phenomena that in turn results in significantly increased self-clinging or binding properties.

### BRIEF DESCRIPTION OF THE DRAWINGS

FIG. 1 is a perspective view of an eyeglass lens protector in accordance with the teachings of the present invention; and

FIGS. 2-4 depict first, second and third stages of application of the eyeglass lens protector to a pair of eyeglasses.

### DETAILED DESCRIPTION OF THE PREFERRED EMBODIMENT

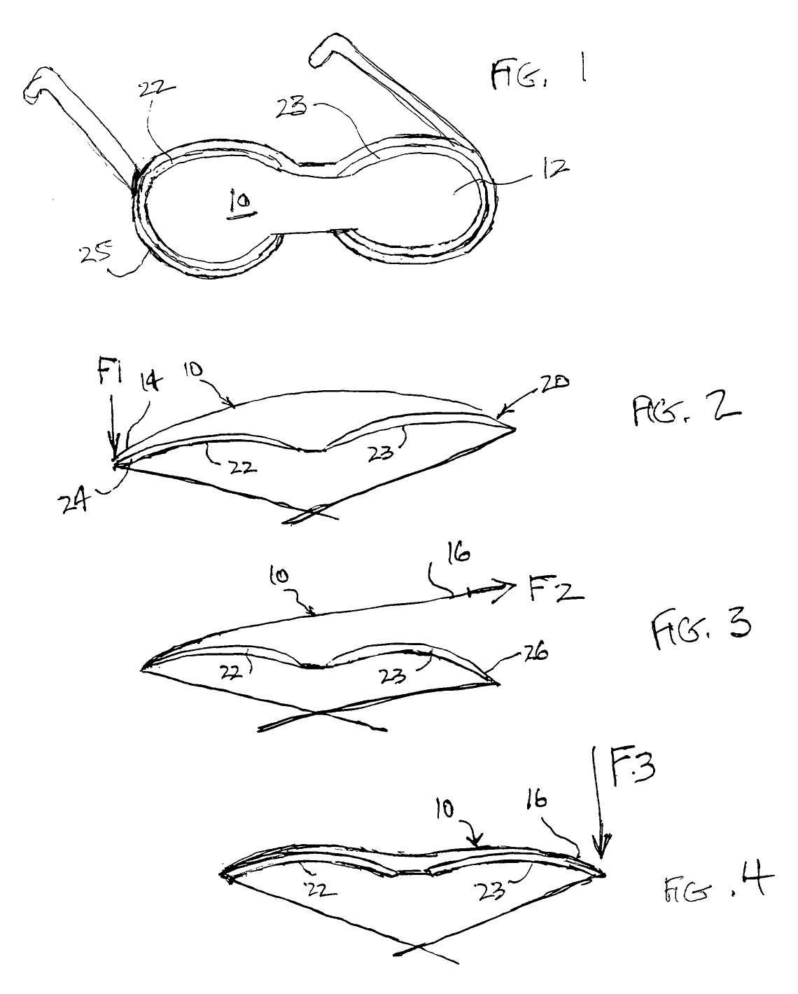

As shown in FIG. 1, the eyeglass lens protector 10 of the present invention comprises an elongated strip 12 of double press polished PVC. The double press polished finishing procedure utilized in the manufacture of the instant invention, as described in applicant's co-pending U.S. application Ser. No. 09/775,874, results in a vinyl strip that is capable of being secured atop an outer surface of the lenses of a pair of eyeglasses, either by pressing the strip onto the lens surface or by stretching the strip and then pressing it on the lens surface.

FIG. 1 shows the eyeglass lens protector 10 of the instant invention after having been applied atop the exterior surface of the pair of lenses 22,23 of a pair of eyeglasses 20. The lens protector strips comprise PVC and are preferably formed with an exterior configuration that substantially matches the exterior configuration of a pair of lenses carried in most conventional eyeglasses. Preferably, the lens protector would be sized to fit the larger lenses of conventional eyeglasses (magnifying, prescription, sun, etc.), and could be trimmed down to fit a smaller size of lenses.

FIGS. 2-4 show various stages of application of the eyeglass lens protector to the exterior surface of the eyeglass lenses. In FIG. 2, the protector strip 10 is first positioned over the two adjacent lenses, and one end 14 of the protector strip 10 is pressed, as indicated by the arrow F1, against a corresponding edge 24 of the first lens 22 which is positioned beneath it. In FIG. 3, the opposite end 16 of the protector strip 10 is stretched, as indicated by the arrow F2, toward the opposite edge 26 of the second lens 23 disposed adjacent the first lens. In FIG. 4, the opposite end 16 of the protector strip 10 is pressed against, as indicated by the arrow F3, the surface of the second lens 23 which is lying beneath and adjacent to the protector strip 10.

The eyeglass lens protectors according to the teachings of the present invention are desirably comprised of 8 to 14-gauge double press polished PVC in thicknesses ranging from three (3) one-thousandths of an inch (i.e., 0.003″) to eighteen (18) one-thousandths of an inch (i.e., 0.018″).

The eyeglass lens protector strips according to the present invention may be made from transparent or colored PVC material, laminated press polished plastic, or reusable pressure sensitive cloth impregnated with plastic. Further the eyeglass lens protector strips may possess a smooth finish on both sides, or they may be formed with surface deformations on one or both sides (eg., via embossing or stamping). The strips can be of solid color or of s solid background on which indicia is placed, as by such techniques as printing, painting, screen printing, lithography, or flexography . . . . Due to its inherent flexibility, the eyeglass lens protector can be folded or crumpled into a ball so that the eyeglass owner, when not using the protector with the glasses, can store the protector in his/her shirt, pants, or jacket pocket without fear of destruction. And it is important to note that the eyeglass lens protector can also be sterilized by traditional non-heat-based methodologies.

The use of double pressed polished PVC for this invention, with its enhanced electrostatic clinging and adhesive properties, results in the ability of the user to apply the invention with the peace of mind that he will be able to quickly and easily remove and reuse it. The economic and related environmental advantages of the instant invention are thus self evident.

It will be apparent that the invention is not limited to the embodiments described above and that variations and modifications may be made thereto within the scope of the invention.

What I claim is:

1. An eyeglass lens protector, comprising:
a strip of vinyl material having adhesive properties, said strip having a configuration which resembles a pair of eyeglass lenses disposed side by side.

2. The eyeglass lens protector of claim 1, wherein said strip of vinyl material comprises double press polished polyvinyl chloride material.

3. The eyeglass lens protector of claim 2, wherein said strip of material is flexible.

4. The eyeglass lens protector of claim 2, wherein said strip of material is of solid color.

5. The eyeglass lens protector of claim 2, wherein said strip of material exhibits indicia on one side thereof.

6. The eyeglass lens protector of claim 5, wherein said indicia is printed on said one side.

7. The eyeglass lens protector of claim 5, wherein said indicia is embossed on said one side.

8. The eyeglass lens protector of claim 1, wherein said strip has a thickness of from about 0.003 inches to about 0.018 inches.

9. The eyeglass lens protector of claim 1, wherein said strip exhibits electrostatic clinging properties.

10. The eyeglass lens protector of claim 1, wherein said strip is flexible and can be folded or crumpled into a ball.

11. A method of protecting the lenses of a pair of eyeglasses from scratching, comprising:
positioning a strip of flexible vinyl material atop an outer surface of said lenses, said vinyl material having at least one surface exhibiting clinging properties, and
pressing said one surface of said strip of flexible vinyl material against and into contact with the outer surface of said lenses.

12. The method of claim 11, and further comprising the step of trimming said strip to the size of said lenses to insure that the strip covers the surface of the lenses.

13. The method of claim 11, and further including, prior to the step of pressing said one surface of said strip of vinyl material against and into contact with the outer surface of said lenses, the step of stretching said strip to render the same taut.

14. The method of claim 11, wherein said strip of vinyl is configured as a pair of side-by-side lenses.

15. The method of claim 11, wherein said strip of vinyl is double press polished.
